(19) United States
(12) Patent Application Publication
(10) Pub. No.: US 2005/0018794 A1
(43) Pub. Date: Jan. 27, 2005

(54) High speed, low-cost process for the demodulation and detection in EDGE wireless cellular systems

(76) Inventors: Xiangguo Tang, Fremont, CA (US); Zhi Ding, Davis, CA (US); Ge Li, Fremont, CA (US)

Correspondence Address: Dr. Zhi Ding, 2603 Nevelson Court, Davis, CA, 95616, US

(21) Appl. No.: 10/624,024

(22) Filed: Jul. 22, 2003

(51) Int. Cl. H04L 27/06

(52) U.S. Cl. 375/341; 375/350

(57) ABSTRACT

A process for signal detection in EDGE cellular systems is presented with the step of wireless channel estimation, a time-reversed signal processor, a soft-output Viterbi signal detector consisting of forward and reverse block processing, a MAP decoder that exchange soft information with the equalizer. Claim 1. A signal detection mechanism to demodulate received data frame that includes an accurate estimator to obtain channel responses, a forward filter and a FIR decision feedback filter to be used in soft-output equalizer, a time-reversal device storing received data in a time-reversed order for reverse block processing, an interference removal apparatus in both forward and reverse processing blocks, and a soft-input soft-output reduced state equalizer that utilizes the forward processing and reversed time processing blocks to generate iterative soft-output signals to the forward error correction decoder within the receiver system.

This invention relates to the demodulation and decoding of data transmitted for the so-called EDGE (Enhanced Data Rates for Global Evolution) system in the field of high-speed digital wireless communication.

### BACKGROUND OF THE INVENTION

An important factor limiting the wide application of wireless internet service is the slow data rate that current cellular system can support. As a high speed alternative, EDGE is one of the third-generation (3G) mobile wireless communication standards. The significance of EDGE is that it builds upon and improves the widely popular GSM cellular system. Without altering the spectral characteristics of GSM, EDGE signal is required to provide high data service by upgrading the binary PSK (phase shift keying) signaling into an 8-PSK modulation. In EDGE systems, every three coded bits are Gray-mapped into an 8-PSK symbol, bring a single user data rate up to 384 kbps. To allow EDGE signal to fit under the GSM spectrum mask, the modulated 8PSK symbols are passed through a GMSK (Gaussian Minimum Shift Keying) pulse-shaping filter. This linearized GMSK pulse is the dominant component in the Laurent linear decomposition of GMSK signals [1].

Since the impulse response of the GMSK shaping filter spans primarily 5 symbol periods, it introduces severe (known) partial-response ISI (inter-symbol interference) to the signals even for ideal channels. Given the 8-PSK modulation in EDGE, maximum likelihood sequence estimation (MLSE) based on the full-state trellis Viterbi algorithm becomes too complex for channels with long or even moderate ISI delay spread. Given an ISI channel consisting of pulse-shaping filter and propagation distortion, the total channel length spans N (>5) symbol durations. The resulting number of states in a full-state trellis equals 8 to the power of N−1. For a Typical Urban (TU) environment [2], the total channel length N could be as large as 6, thereby requiring a total of 32768 states, which is too costly to be implemented to hardware upon current technology. To alleviate the computational complexity, reduced-state suboptimal MLSE equalizer using delayed decision feedback (DDF) sequence estimation [3] has been adopted to EDGE equalization preceded by channel re-shaping prefilters. Typically, significant performance loss accompanies these suboptimal MLSE schemes.

To further improve the detection performance, the procedure of turbo equalization can be explored. Turbo detection for EDGE system may be applied with a full-state Max-Log-MAP channel equalizer [4]. To simplify the highly complex Max-Log-MAP equalizer, a simpler MMSE-BDFE with a priori information can be utilized [5]. To achieve a good tradeoff between the detection performance and the computational complexity, a suboptimal MAP equalizer combining soft output Viterbi algorithm (SOVA) [6] and reduced-state trellis formed by DDF can be very effective [7]. It is important to note, however, that this DDF-SOVA is still subject to error propagation. In fact, decision feedback error propagation is a major factor that degrades the equalizer output reliability.

The objective of the present invention is to improve the EDGE receiver by alleviate error propagation by integrating the bi-directional arbitrated decision in EDGE detection. Bi-directional processing was originally designed to improve the symbol detection accuracy for decision feedback equalizer (DFE) by making arbitrations between the output sequences from two DFEs operating on opposite directions. For suboptimal EDGE turbo equalization system, soft decisions are needed. Hence, we add a reversed-time DDF-SOVA equalizer, which processes the time-reversed signal sequence of the received EDGE signal bursts, to the existing forward DDF-SOVA equalizer. The soft outputs from the forward and reverse DDF-SOVA equalizers are integrated to exploit the time-reversal diversity resulted from the error propagation in DDF reduced-state trellis processing. A simple scheme for combining soft-information from the forward and reverse DDF-SOVA equalizers is also invented.

Due to the use of channel re-shaping prefilters as feedforward filter to reduce feedback DDF trellis, a much low complexity DDF-SOVA equalizer can be practically implemented. By applying the bi-directional arbitrated decision DDF-SOVA architecture into EDGE detection, a much reliable and low complex EDGE detection scheme become practical.

### SUMMARY OF THE INVENTION

The primary aspect of the invention is to present a low cost, practical receiver technology that meets and improves the detection performance of EDGE system providing a signal received from a single antenna, comprising the steps of: for every 4 bursts of received signal corresponding to the transmitted EDGE frame of 592 symbols, sampling at the symbol rate; and storing the sampled data to estimate the wireless channel impulse response via cross-correlation according to the mid-amble training data in all 4 bursts; and designing MMSE pre-filter and DFE (decision feedback equalizer) based on the channel estimates [8]; and reversing the channel response to design a time-reversed (TR) MMSE pre-filter and a DFE; and processing all the received data samples once by the first (forward time) pre-filter and DFE; and processing the TR signal samples by the second (time-reversed) pre-filter and DFE; and taking both soft outputs from the two DFE output to form a weighted combination for soft-output 8PSK symbol value from the equalizer; and deriving soft-bit outputs from the soft 8PSK symbol output value via Max-Log nonlinearity; and de-interleaving the bit soft-outputs before sending them to a MAP decoder for the FEC (forward error correction) code; and generating soft extrinsic [6] output from the MAP decoder; and interleaving MAP outputs before forming the soft bit extrinsic information; and feeding the soft bit extrinsic information directly to DFE to complete the iteration; and terminating the said turbo-equalization when extrinsic information become stable.

The step of signal collection and channel estimation comprises sampling 4 bursts of modulated signals based on an acquired timing clock, storing the received data samples in memory, using cross-correlation between the training mid-amble and the received data to estimate the nearly-stationary, unknown wireless channel response.

The step of pre-filter and DFE design can comprise the MMSE (minimum mean square error) design in the forward direction, and the MMSE filter design based on the received channel response and reversed data sample sequence.

A key element for simplifying the receiver complexity requires the use of a bi-directional equalizer, comprising: a forward direction DFE with pre-filtering and a reverse direction DFE with pre-filtering; a max-log nonlinearity in the forward and the reverse equalizers to generate soft bit value information; a hard decision device for generating decision bits that form the DFE filter input in the forward and the reverse direction; a summation prior to the hard-decision device for inputting soft extrinsic values; and a weighted linear combiner to combine the forward DFE and the reverse DFE soft-symbol information to be sent to the de-interleaver and the MAP decoder.

Another aspect of the invention provides a generalization of the bi-directional DFE through the use decision-delayed feedback (DDF) for improved performance using reduced state trellis, comprising: a soft-output-Viterbi-algorithm (SOVA) equalizer that directly provides soft bit information for turbo processing; a flexible design of trellis with different levels of complexity according to the number of states 8^{k-1} determined by the k leading samples of the channel impulse response.

Each receiver can comprise more than one antenna and radio frequency circuits for providing multiple received signal sequences corresponding to the same transmitted data frame, and can be directly incorporated in the bi-directional equalizer design with the estimation of a single-input-multiple output channel response and the design of multiple-input-single-output pre-filters in both the forward and the reverse directional circuits.

Each receiver can also comprise faster samplers for providing multiple received signal sequences corresponding to the same transmitted data frame, and can be directly incorporated in the bi-directional equalizer design with the estimation of a single-input-multiple output channel response and the design of multiple-input-single-output pre-filters in both the forward and the reverse directional circuits.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is the block diagram of DDF-SOVA turbo receiver for EDGE wireless communications system.

FIG. 2 is the block diagram of a transmitter in communications system.

FIG. 3 is the block diagram of a conventional receiver in communications system.

FIG. 4 is the modulation procedure of EDGE's 8-PSK signal.

FIG. 5 is the constellation for 8-PSK Gray mapping in EDGE system.

FIG. 6 is the linearized GMSK shaping pulse in EDGE system.

FIG. 7 is the format of an EDGE burst.

FIG. 8(a) is the magnitude of a symbol-rate sampled TU channel impulse response. FIG. 8(b) is the magnitude of the channel impulse response after prefiltering.

FIG. 9 is the bock diagram of bi-directional DDF-SOVA turbo receiver for EDGE wireless communications system.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Referring to FIG. 2, there is shown the basic block diagram of a baseband transmitter in a communications system. The input information bits first go into a channel encoder to introduce redundancy for the purpose of error correction at the receiver side. Then the coded bits are sent into the modulator to form the transmitted symbols according to the specific modulation rules such as QAM, PSK and so on. Those modulated symbols finally are transmitted into the non-perfect channel with intersymbol interference.

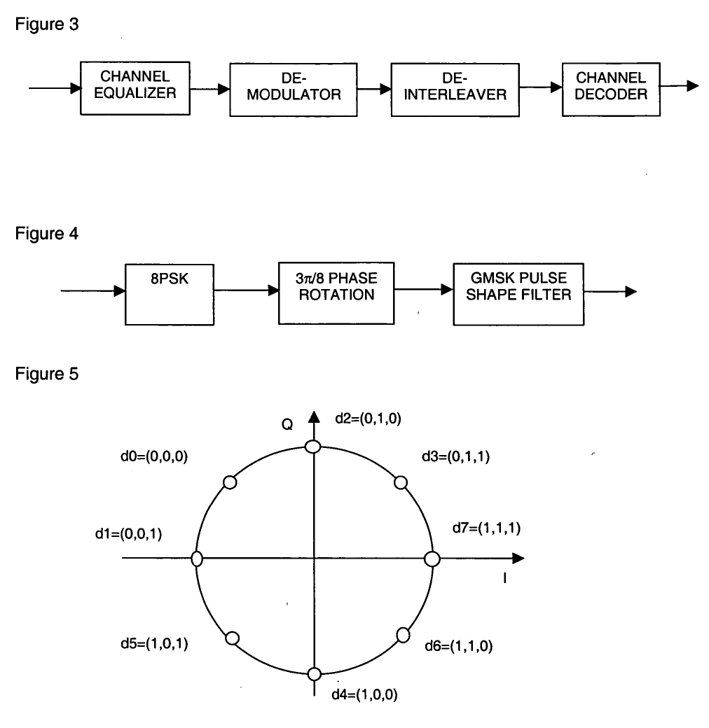

Referring to FIG. 3 shows the structure of a digital baseband processing portion of a conventional receiver in a communications system. The received signal samples are first passed into the channel equalizer to compensate the channel intersymbol interference. The estimated symbols are then sent to the demodulator to generate bits according to the specific modulation rules. Afterward, the channel decoder recovers the information bits from the output of demodulator.

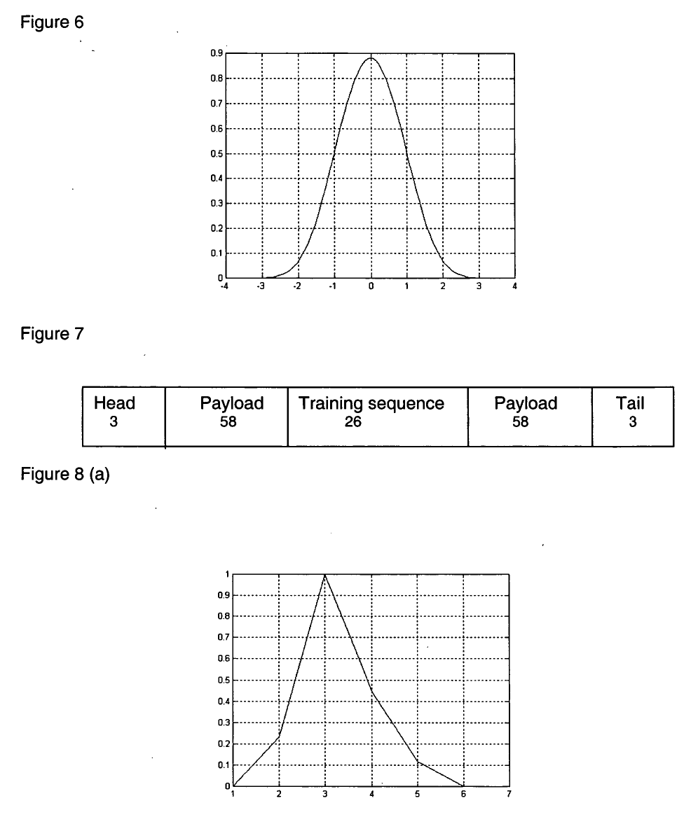

Referring to FIG. 4 illustrates the specific modulation procedure in an EDGE transmitter. Every three encoded bits are converted into an 8-PSK symbol based on Gray mapping. The constellation of Gray mapping is shown in FIG. 5. To avoid signal envelope zero-crossing, the modulated symbols are continuously rotated by 3π/8 on a symbol-by-symbol basis. To make EDGE signal fit into GSM spectrum mask, the rotated symbols are sent into a linearized GMSK pulse-shaping filter. As shown in FIG. 6, the duration of this filter impulse response last about 5 symbols. As a result, significant intersymbol interference is introduced even before the signal is sent into the channel.

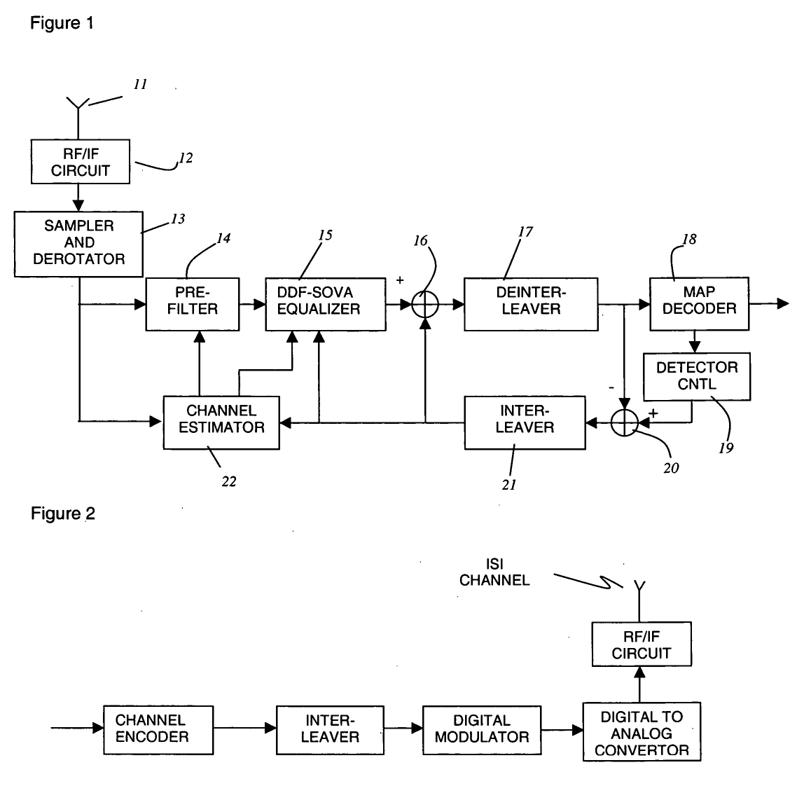

Referring to FIG. 1, there is shown the block diagram of the EDGE turbo receiver. Unlike the conventional receiver structure as shown in FIG. 3, the turbo receiver has information feedback path from 18, 19, 20, 21 to 15. The turbo receiver consists of seven components, namely, channel estimator 22, prefilter 14, soft-input-soft-output channel equalizer 15, deinterleaver 17, soft-input-soft-output channel decoder 18, detection controller 19 and interleaver 20. Specifically in this embodiment, a DDF-SOVA equalizer is used as the soft-input-soft-output equalizer 15 for its low implementation complexity. The soft-input-soft-output decoder 18 could be any MAP or suboptimal MAP decoder.

Channel estimator 22 is used to estimate channel impulse response and provide coefficients to the prefilter 14 and channel equalizer 15. The channel could be estimated by using the training sequence, which is available in each EDGE burst as shown in FIG. 7.

After first turbo iteration, the estimated symbols of the whole burst could be used as training symbols to refine the channel estimate iteratively.

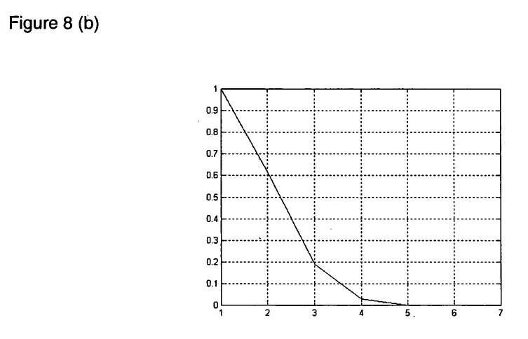

Prefilter 14 is designed to shorten the channel impulse response, which is critical to ensure good detection performance of the subsequent DDF-SOVA equalizer 15. One embodiment of this prefilter 14 is to use the feedforward filter in a decision feedback equalizer (DFE) designed for the estimated channel. Subsequently, feedback filter coefficients of the DFE can be used by the DDF-SOVA equalizer 15 to form the corresponding trellis. FIG. 8(a) shows the magnitude of a TU channel impulse response. FIG. 8(b) shows the shortened channel impulse response with the assistance of a prefilter 14.

Reduced-complexity soft-input-soft-output equalizer 15 is a critical component for the EDGE turbo receiver. In this embodiment, delayed decision feedback (DDF) sequence estimation approach is adopted to reduce the trellis state. In full-state trellis algorithm, trellis is formed based on all N channel taps. While in DDF, only the leading K<N channel taps are used to define the trellis, therefore the number of states is reduced from 8^{N-1} to 8^{K-1} for EDGE's 8-PSK modulation. Metrics are calculated based on symbols corresponding to current states as well as previously estimated symbols associated with the current survivor. Since only the first K channel taps are involved with the trellis structure, DDF operates well for channels with concentrated energy in the leading taps. This prompts the use of the prefilter 14 to re-shape the channel response. Based on the reduced-state trellis, any MAP algorithms can be chosen to calculate the soft output values, which is defined as:

$$L ( {c}_{k} ) = log [ \frac{Pr ( {c}_{k} = 1 )}{Pr ( {c}_{k} = 0 )} ] ,$$

For EDGE system with 8PSK modulation, a transform soft values dₖ between 8PSK symbols {Sₖ} and coded bits {Cₖ} is required, as a result, soft output values are calculated as:

$$\begin{matrix}{L}_{{d}^{( m )}} ( {d}_{k} ) = log [ \frac{Pr ( {d}_{k} = {d}^{( m )} )}{Pr ( {d}_{k} = {d}^{( 0 )} )} ] \\ = log [ \frac{{\prod }_{i = 1}^{3} Pr ( {c}_{k , i} = {d}^{( m )} ( i ) )}{{\prod }_{i = 1}^{3} Pr ( {c}_{k , i} = {d}^{( 0 )} ( i ) )} ] \\ = {\sum }_{{d}^{( m )} ( i ) = 1}^{} L ( {c}_{k , i} )\end{matrix}$$

where d^{(m)}(i) is the i^{th} bit of symbol d^{(m)}, c_{k,l} is the i^{th} bit of the k^{th} symbol. In this embodiment, the soft-output-viterbi-algorithm (SOVA) is used for its simplicity.

The soft outputs from the channel equalizer 15 are deinterleaved by 17 and forwarded to the channel decoder 18. The soft decisions on the encoded bits are then fed back into the channel equalizer 15 after interleaved by 21. These soft decisions are referred as a prior information for the transmitted signal. The a prior information can assist the channel equalizer 15 to obtain more reliable signal detection in the next iteration. The subtractors 16, 20 are used to retain only the extrinsic soft values, which represent the incremental information about current bits (symbols). After a number of iterations which is controlled by detection controller 19, hard decisions on the information bits can be made by slicing the soft values of the information bits.

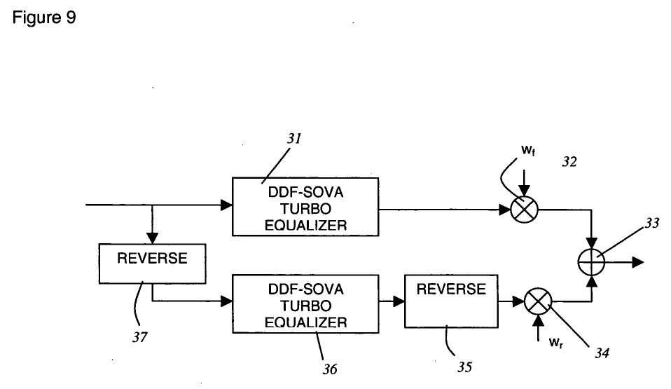

To further improve the detection performance, bi-directional processing can be applied to the DDF-SOVA turbo equalizer as shown in FIG. 9. The bi-directional turbo equalizer includes two turbo equalizers 31,36. One is referred as forward turbo equalizer 31, which processes the received signal burst. Another is referred as reverse turbo equalizer 36, which processes the reversed version of the received signal burst. In the reverse turbo equalizer, the prefilter and DDF-SOVA trellis coefficients are based on the DFE decomposition of the reversed version of the channel estimate. The soft decisions from the reverse turbo equalizer 36 are reversed by 35 and then linearly combined with the soft decisions from the forward turbo equalizer 31. The combination weights for the two output sequences could be simply equal. They can also be chosen based on other criterions.

1. A digital baseband receiver of low complexity for demodulation and detection in EDGE wireless cellular systems comprising:
an accurate estimator for wireless channel response;
a prefiler and DFE filter design and implementation;
a time-reversed block processor;
a forward block processor;
a soft-output equalizer integrating forward and reversed DFE outputs through convex combination;
an option of utilizing maximum a-posteriori (MAP) bi-directional equalizer in lieu of the bi-directional DFE consisting of forward and reverse soft-output Viterbi processing blocks;
a MAP outer decoder after de-interleaver to generate soft bit output information, the soft bit output information being feed back to interleaver before used by the equalizer as extrinsic information, the exchange of soft information between equalizer and decoder forming an iterative process to be terminated by a control block monitoring the quality of extrinsic output of the MAP decoder.

2. The digital baseband receiver of claim 1 wherein
a) the channel estimator for wireless channel response defines an accurate estimator to obtain unknown channel responses through transmitted training data, said estimator being able to determine a forward finite impulse response (FIR) forward filter and an FIR decision feedback filter to be used in soft-output equalizer.
b) the prefilter defines a FIR filter with coefficients derived from results of the accurate estimator defined in claim 2.
c) the time-reversed block processor defines a time-reversal device that utilizes memory to store received data in a time-reversed order for reverse block processing.
d) The digital baseband receiver of claim 1 wherein the low complexity equalizer takes convex combination of the forward DFE output and the time-reversed DFE output to define a soft input and soft output bit information to be forwarded to the interleaver and the MAP decoder.
e) The digital baseband receiver of claim 1 wherein the soft-output Viterbi signal detector defines a soft-input, soft-output viterbi detector, a hard-decision unit to obtain binary information, a decision unit to determine if further iterative operation is required.
f) The digital baseband receiver of claim 1 wherein the detection controller defines a control unit to control iterative process based on a criterion to warrant a given performance requirement.

3. The baseband receiver system in claim 1 wherein said MAP decoding algorithm means includes means for generating iterative sequences of soft output values for each coded bits and message bits representing log likelihood ratio.

4. The baseband receiver system in claim 1 wherein said bi-directional equalizer includes means based on forward and time-reversed block processing and combining to generate soft symbol and bit information for outer decoder applications.

5. The baseband receiver system in claim 1 wherein said input signal includes signals obtained from down-converting and sampling single and multiple antenna RF outputs.

6. The baseband receiver system in claim 1 wherein said sampler includes baud rate and higher rate samples to generate equalizer input signals.
